(19) United States
(12) Patent Application Publication
(10) Pub. No.: US 2014/0364231 A1
(43) Pub. Date: Dec. 11, 2014

(54) CONTROLLERS FOR USE WITH MOBILE DEVICES

(71) Applicant: Bensussen Deutsch & Associates, Inc., Woodinville, WA (US)

(72) Inventors: Steven Mitchell Cramer, Redmond, WA (US); Craig Stuart Erickson, Rocklin, CA (US); Treasure Lynae Hinds, Seattle, WA (US); Gregory Thomas Janky, Sammamish, WA (US)

(21) Appl. No.: 13/914,552

(22) Filed: Jun. 10, 2013

(51) Int. Cl. A63F 13/20

(52) U.S. Cl. CPC A63F 13/06
USPC 463/37

(57) ABSTRACT

A controller for use with a mobile device is provided. The controller includes a video game controller; and a mobile device holder including a frame, a lock member, and a spring. The frame is pivotably coupled to the video game controller to rotate between a range of setting angles with respect to the video game controller. The frame member is coupled to the lock member via a spring, such that the lock member is slidably moveable to a retracted and an extended configuration. The lock member is biased toward the retracted configuration by the spring to retain the mobile device in the mobile device holder during use. Other related controllers and systems for use with mobile devices are also provided.

### BACKGROUND

1. Technical Field

The present disclosure is generally related to controllers, and more particularly, to controllers for use with mobile devices.

2. Description of the Related Art

Mobile devices are widely used for playing video games. Several video game developers have made available games especially suitable for playing on mobile devices, such as smart phones. Using touch screens or mobile device keys, however, may be unsuitable and may present challenges for effectively playing such games. Therefore, video game controllers may be used to play video games on mobile devices. The video game controllers may be connected to the mobile devices via a wireless connection or a wired connection.

Playing a video game connected to mobile devices may present further challenges because the mobile device may need to be placed on a different platform, such as a desk or a table, from the one the video game controller is placed on, thereby separating the video game controller from the mobile device. Placing the mobile device apart from the video game controller may reduce the effectiveness of a player with respect to the player's hand-eye coordination, concentration, and convenience. For example, the player may have to look in a downward direction to view the mobile device placed on a flat surface, while the video game controller is held in the player's hands, which may have an adverse impact on the player's concentration or hand-eye coordination. Similarly, if the player is travelling on a bus or train, for example, the player may not find a suitable surface to place the mobile device on, thereby making playing video games on mobile devices particularly inconvenient.

### BRIEF SUMMARY

The embodiments described herein provide controllers and related systems that are well adapted to provide a convenient and effective gaming environment.

According to one embodiment, a controller for use with a mobile device may be summarized as including a video game controller and a mobile device holder including a frame, a lock member, and a biasing means. The frame is pivotably coupled to the video game controller to rotate between a range of setting angles with respect to the video game controller, and the lock member is coupled to the frame to slidably move between a retracted configuration and an extended configuration for receiving the mobile device therein. Further, the lock member is biased toward the retracted configuration by the biasing means to retain the mobile device in the mobile device holder during use.

According to another embodiment, a system to clamp a mobile device during use may be summarized as including a video game controller; a mobile device holder including a lock member configured in a substantially L-shape; a frame also configured in a substantially L-shape, the frame including an opening for receiving the lock member to form a substantially C-shaped clamp; and a spring. The spring couples the lock member to the frame such that the lock member is slidably moveable between a retracted configuration and an extended configuration, wherein the lock member is biased toward the retracted configuration by the spring to retain the mobile device in the mobile device holder. The system also includes a hinge mechanism configured to pivotably couple the mobile device holder to the video game controller, such that the mobile device holder is rotatable between a range of setting angles with respect to the video game controller.

According to yet another embodiment, a controller for use with a mobile device may be summarized as including a videogame controller, a mobile device holder, and a counterbalance weight. The mobile device holder is pivotably coupled to a first end of the videogame controller to allow for varying of a setting angle with respect to the videogame controller, and the mobile device holder is configured to retain the mobile device during use, which may shift a center of gravity of the videogame controller. The counterbalance weight is coupled to the videogame controller, where the counterbalance weight is selectively positioned at an opposed end with respect to the first end of the videogame controller to prevent the center of gravity shifting beyond a tip-over point.

### BRIEF DESCRIPTION OF THE SEVERAL VIEWS OF THE DRAWINGS

FIG. 1 is an isometric view of a controller, according to one embodiment, wherein a mobile device holder is in an inclined and retracted configuration.

FIG. 2 is a side elevational view of the controller of FIG. 1, wherein the mobile device holder is shown in various angular settings and moveable configurations.

FIG. 3 is a top isometric view of the controller of FIG. 1, wherein the mobile device holder is in a closed and retracted configuration.

FIG. 4 is a front view of the controller of FIG. 1, wherein the mobile device holder is shown having received a mobile device.

FIG. 5 is an isometric view of a controller, according to an alternate embodiment, wherein a mobile device holder is in an inclined and retracted configuration.

FIG. 6 is a side elevational view of the controller of FIG. 5, wherein the mobile device holder is shown in various angular settings and moveable configurations.

### DETAILED DESCRIPTION

The following detailed description is directed toward devices and systems for using controllers with mobile devices. The following detailed description and corresponding figures are intended to provide an individual of ordinary skill in the art with enough information to enable that individual to make and use embodiments of the invention. Such an individual, however, having read this entire detailed description and reviewed the figures, will appreciate that modifications can be made to the illustrated and described embodiments, and/or elements removed therefrom, without deviating from the spirit of the invention. It is intended that all such modifications and deviations fall within the scope of the invention, to the extent they are within the scope of the associated claims.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

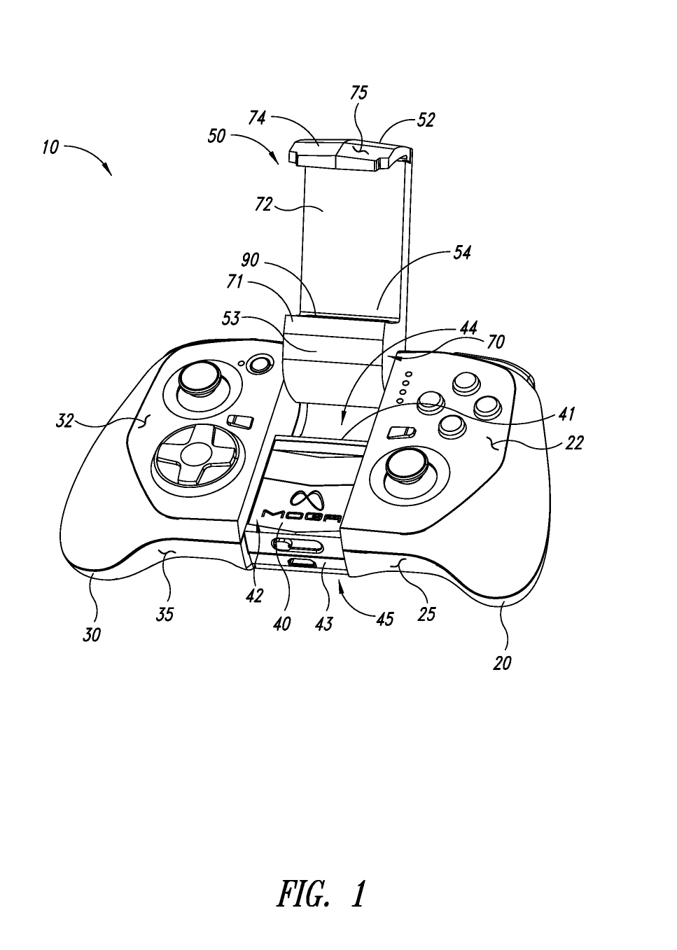

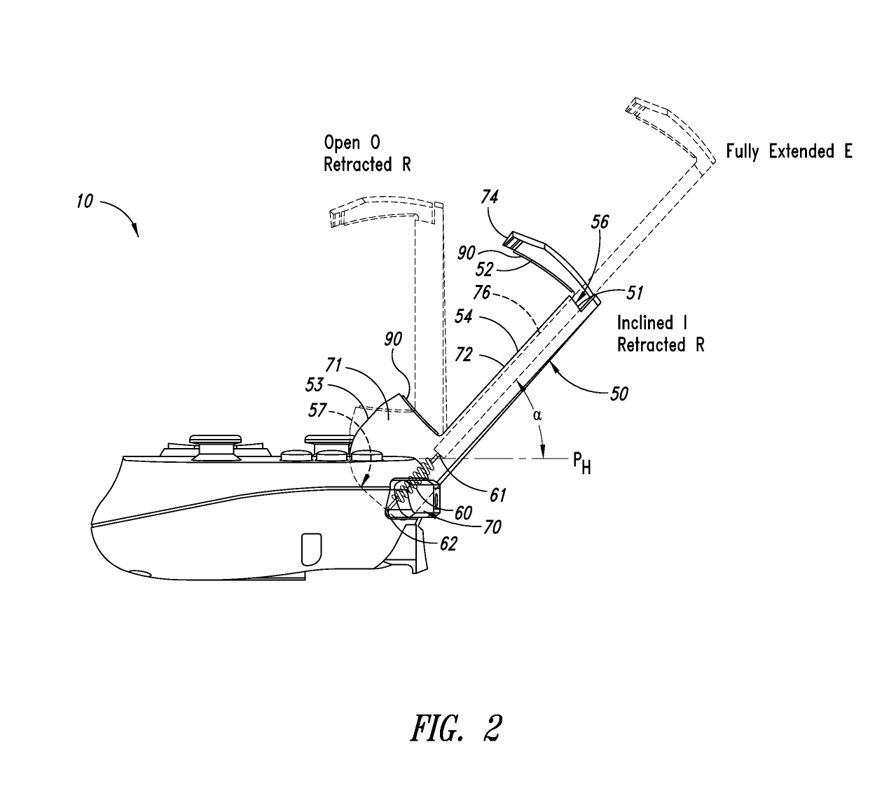

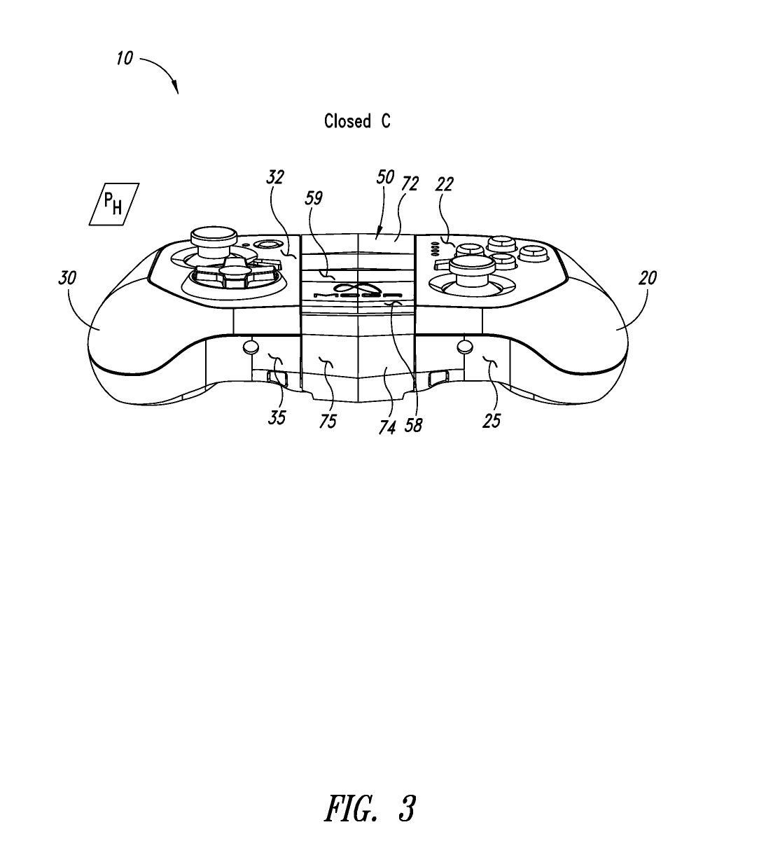

FIGS. 1 through 3 illustrate an example embodiment of a controller 10 shown in various adjustable angular settings and moveable configurations. The controller 10 primarily includes a right side portion 20, a left side portion 30, a center portion 40, and a mobile device holder 50. As best seen in FIGS. 2 and 3, the mobile device holder 50 is rotatable to an open configuration O, a closed configuration C, and an inclined configuration I. Further, the mobile device holder 50 can be in a retracted configuration R or may be extended from a retracted configuration R to a fully extended configuration E. The center portion 40 includes opposing lateral ends 41, 43. At lateral end 41, the center portion 40 includes a first opening 44 adapted to receive therein the mobile device holder 50, such that the mobile device holder 50 can be pivotably coupled to the right and left side portions, 20, 30, via a hinge mechanism 70. The hinge mechanism 70 may include a biaxial hinge, a rotary hinge, a clamshell type hinge, or other forms of hinges that may permit the mobile device holder 50 to be rotatable at various angle settings. As best seen in FIGS. 2 and 3, the hinge mechanism 70 permits the mobile device holder 50 to be oriented at various angles: in the open configuration O, the mobile device holder 50 can be substantially perpendicular to a horizontal reference plane P_{H} of the controller 10; in the closed configuration C, the mobile device holder 50 can be oriented substantially parallel to the horizontal reference plane P_{H}; and in the inclined configuration I, the mobile device holder 50 can be oriented at an angle a with respect to the horizontal reference plane P_{H}. Although in the shown embodiment, the angle a is about 135° with respect to the horizontal reference plane P_{H} in the inclined configuration I, an individual of ordinary skill in the art, having reviewed this entire disclosure, will immediately appreciate that variations to the orientation of the mobile device holder 50 in the inclined configuration can be made by simply configuring the hinge mechanism 70 such that the mobile device holder 50 may snap into position at any suitable angle α.

With reference to FIGS. 1 through 3, the mobile device holder 50 includes a frame 54, a lock member 52, and a spring 60. The frame 54 includes an aperture (not shown) extending through a lower portion 53 of the frame 54. The aperture allows a hinge shaft of the hinge mechanism 70 to pass through. At an upper end 51 of the frame 54, an opening 56 is provided for receiving the lock member 52. The opening 56 permits the lock member 52 to slidably move from a retracted configuration R to a fully extended configuration E. The spring 60 of the lock member 52 is biased towards the retracted configuration R. The spring 60 includes two opposing ends 61, 62. The end 62 of the spring 60 is coupled to an interior surface 57 of the lower portion 53 of the frame 54. The opposing end 61 of the spring 60 is coupled to the lock member 52 such that, as the lock member 52 is slidably extended, the biasing of the spring 60 forces the mobile device holder 50 to retract to the retracted configuration R. Although the shown embodiment includes one spring 60, in other embodiments, two springs or a multitude of springs may also be used.

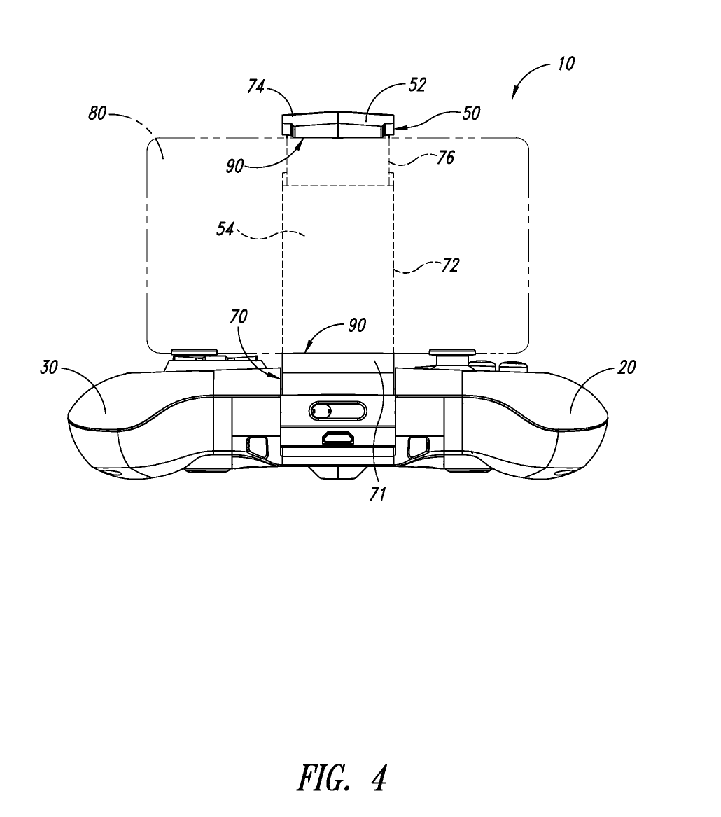

With reference to FIGS. 1 and 2, the frame 54 is formed from a substantially L-shaped angle, including a base flange 71 and an upstanding flange 72. The lock member 52 is also formed from a substantially L-shaped angle that includes a base flange 74 and an upstanding flange 76. As the lock member 52 is mounted within the frame 54 via spring 60, the mobile device holder 50 forms a substantially C-shaped clamp. Therefore, during use, to provide for a stable and convenient gaming environment, a user may slidably lift the lock member 52 toward the extended configuration E, until a suitable height is reached. Thereafter, as shown in FIG. 4, a mobile device 80 may be positioned within the mobile device holder 50 and the lock member 52 may then be released until the mobile device 80 is sufficiently clamped in place. The mobile device 80 may be a smart phone, a tablet, a dumb phone, or any other mobile device. The mobile device 80 may be positioned within the mobile device holder 50 in any suitable orientation, such as a vertical or a horizontal orientation. To protect the mobile devices from scratches or other forms of damage and also to provide a firm grip when the mobile device 80 is received by the mobile device holder 50, grip pads 90 are coupled to the base flanges 71, 74 of the frame 54 and lock member 52, respectively.

Moreover, an individual of ordinary skill in the art, having reviewed this entire disclosure, will immediately appreciate that variations can be made to the mobile device holder 50 without deviating from the spirit of the invention. For instance, in the shown embodiment, the mobile device holder 50 is centrally positioned with respect to the controller 10 and is oriented in a vertical fashion with respect to the horizontal plane P_{H} during use; however, in other embodiments the mobile device holder 50 may be oriented in a horizontal fashion, such that the lock member and the frame may extend horizontally from a retracted configuration to a fully extended configuration. Similarly, although the shown embodiment retains the mobile device 80 through the frame 54 and the lock member 52 forming a C-shaped clamp, in other embodiments, the mobile device holder 50 may not include the lock member 52 and may retain the mobile device 80 by using suitable attaching means, such as Velcro, for example.

With reference back to FIGS. 1 through 3, the first opening 44 extends through the center portion 40, and the size of the first opening 44 is configured to permit rotation of the mobile device holder 50 without interfering with the center portion 40. Although in the embodiment shown, the opening 44 extends through the center portion 40, in other embodiments, the opening may be a recess adapted to receive therein the mobile device holder 50 and also permitting rotation thereof without interference with the center portion 40. At the other lateral end 43 of the center portion 40, the center portion 40 includes a second opening 45, which also extends through the center portion 40. As best seen in FIG. 3, the second opening 45 is configured for receiving the base flange 74 of the lock member 52, such that in the closed C and retracted R configurations, an external surface 75 of the base flange 74 is substantially flush with external surfaces 25, 35 of the right side portion 20 and the left side portion 30, respectively. The center portion 40 further includes a recess 42 that is configured for receiving the frame 54 of the mobile device holder 50. As best seen in FIG. 3, in the closed configuration C and the retracted configuration R, the depth of the recess 42 is adapted such that an external surface 59 of the frame 54 and an external surface 58 of the lock member 52 are substantially flush with each other and with an upper surface 32 of the left side portion 30 and an upper surface 22 of the right side portion 20. Further, the recess 42 is adapted to function as a stop when the mobile device holder 50 is rotated to the closed configuration C.

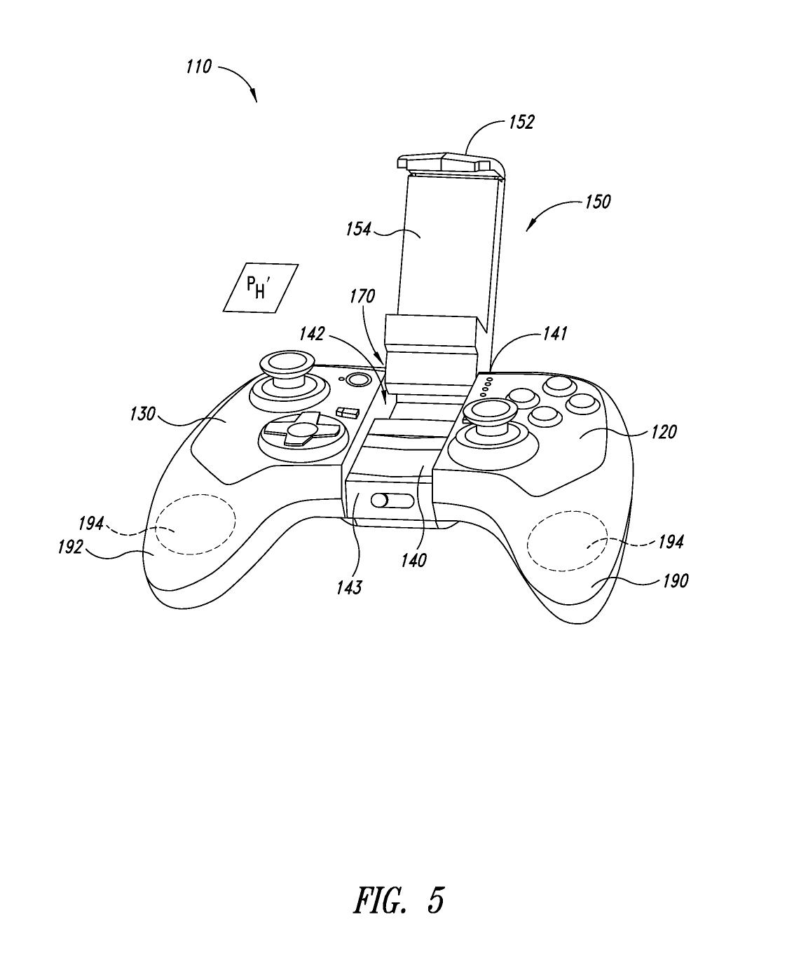

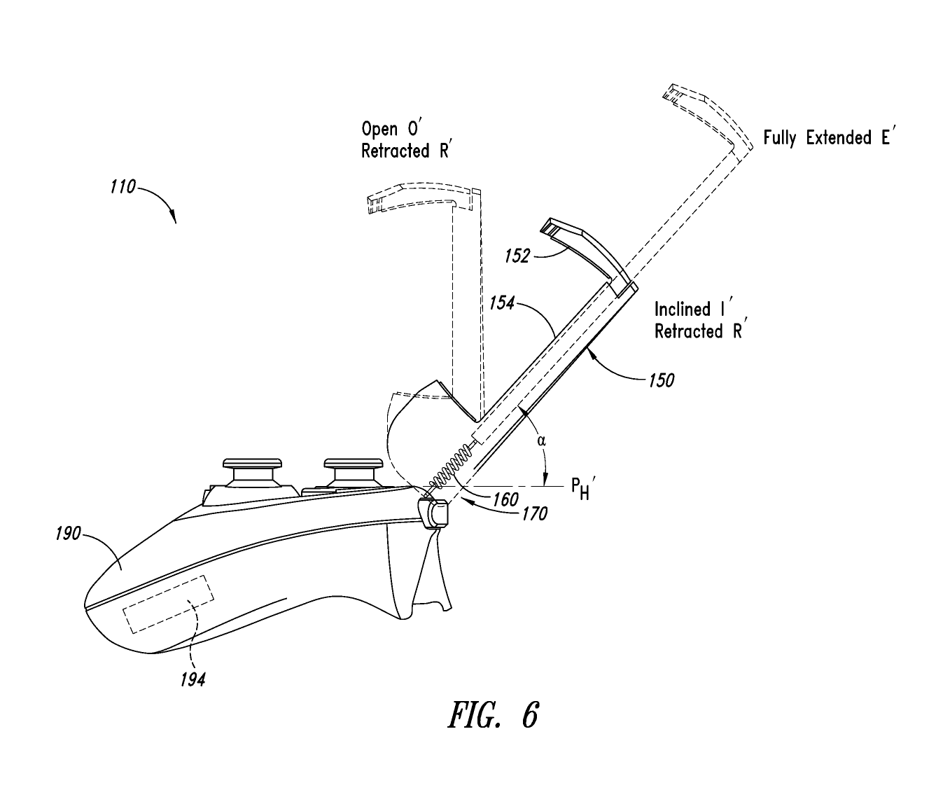

FIGS. 5 and 6 illustrate a controller 110, according to another embodiment. The controller 110 includes a right side portion 120, a left side portion 130, a center portion 140, and a mobile device holder 150. The mobile device holder 150 is rotatable to an open configuration O′, closed configuration C′ (not shown), and an inclined configuration I′ via a hinge mechanism 170. The mobile device holder 150 includes a lock member 152, a frame 154, and a spring 160. The lock member 152 is slidably extendable to a fully extended configuration E′ and retractable to a retracted configuration R′ in all three open O′, closed C′, and inclined I′ configurations, thereby permitting the mobile device holder 150 to receive therein a mobile device (not shown).

With continued reference to FIGS. 5 and 6, the center portion 140 includes a substantially C-shaped recess 142 that extends laterally from a lateral end 141 to an opposing lateral end 143. The C-shaped recess 142 is adapted for receiving therein the mobile device holder 150, such that the mobile device holder 150 can be hingedly coupled to the right and left side portions 120, 130 at the end 141. The depth of the recess 142 at the end 141 is further configured to permit rotation of the mobile device holder 150 without interference with the center portion 140. The depth of the recess 142 at the opposing lateral end 143 is configured for receiving therein the lock member 152 of the mobile device holder 150 in the closed configuration C′. Still further, the recess 142 is configured such that the mobile device holder 150 sits substantially flush with the right and left side portions 120, 130 in the horizontal and vertical directions in the closed configuration C′.

With continued reference to FIGS. 5 and 6, the right side and left side portions 120, 130 include respective hollow grips 190, 192. The hollow grips 190, 192 may be made of rubber or other suitable material that provides sufficient gripping ability and facilitates moisture absorption. The hollow grips 190, 192 are configured for receiving therein respective weights 194, which are positioned within the hollow grips 190, 192 such that the weights 194 counterbalance a shift in the center of gravity that results when the mobile device holder 150 receives a mobile device (not shown). For instance, if the mobile device holder 150 is not oriented perfectly upright, forming a right angle with a horizontal reference plane P_{H}′ of the controller 110, then a horizontal force component results that applies a tipping force to the controller 110. The weights 194 positioned at an opposing end of the controller 110, however, counterbalance the tipping force and therefore keep the controller 110 balanced and stable. Although the embodiment shown includes hollow grips, an individual of ordinary skill in the art, having reviewed this entire disclosure, will immediately appreciate that further variations can be made to the controller 110 without deviating from the spirit of the invention. For instance, the right side and left side portions, 120, 130 may not include hollow grips and the weights may be positioned within the right side and left side portions 120, 130. Further, the weights may be of any suitable shape, such as spherical shaped, hockey puck shaped, square shaped, or another suitable shape. The weights may be attached to the controllers via adhesives, a suitably shaped housing within the controllers may be provided to house the weights, or other suitable means may be used to attach the weights to the controllers. Still further, the weights may be made of lead, rubber, or any other material with appropriate densities that will aid in counterbalancing the shift in the center of gravity.

Moreover, the various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A controller for use with a mobile device comprising:
a video game controller; and
a mobile device holder including a frame, a lock member, and a biasing means, wherein:
the frame is pivotably coupled to the video game controller to rotate between a range of setting angles with respect to the video game controller;
the lock member is coupled to the frame to slidably move between a retracted configuration and an extended configuration for receiving the mobile device therein, the lock member is biased toward the retracted configuration by the biasing means to retain the mobile device in the mobile device holder during use.

2. The controller of claim 1 wherein the mobile device holder is adapted to retain a smart phone.

3. The controller of claim 1 wherein the lock member and the frame are configured to form a C-shaped clamp to retain the mobile device in the mobile device holder during use.

4. The controller of claim 1 wherein the frame is pivotably coupled to the video game controller via a hinge mechanism.

5. The controller of claim 1 wherein the video game controller includes a right side portion, a left side portion, and a center portion, the center portion including an opening at a first lateral end of the video game controller to pivotably couple the mobile device holder.

6. The controller of claim 5 wherein the mobile device holder is rotatable to at least a closed setting, an open setting, and an inclined setting.

7. The controller of claim 6 wherein the frame is configured in a substantially L-shape.

8. The controller of claim 7 wherein the lock member is configured in a substantially L-shape.

9. The controller of claim 8 wherein an external surface of a base flange of the lock member is substantially flush with a second lateral end of the video game controller in the closed setting and the retracted configuration, the second lateral end being an opposed end of the first lateral end.

10. The controller of claim 8 wherein an external surface of an upstanding flange of the frame and an external surface of an upstanding flange of the lock member is substantially flush with an upper surface of the right side portion and an upper surface of the left side portion in the closed setting and the retracted configuration.

11. The controller of claim 8 further comprising:
a pair of grips to protect the mobile device from damage, wherein each grip is coupled to a respective interior surface of a base flange of the lock member and a base flange of the frame, each interior surface contacting the mobile device during use.

12. A system to clamp a mobile device during use, the system comprising:
a video game controller;
a mobile device holder including:
a lock member configured in a substantially L-shape
a frame configured in a substantially L-shape, the frame including an opening for receiving the lock member to form a substantially C-shaped clamp; and
a spring, the spring coupling the lock member to the frame such that the lock member is slidably moveable between a retracted configuration and an extended configuration, wherein the lock member is biased toward the retracted configuration by the spring to retain the mobile device in the mobile device holder; and
a hinge mechanism configured to pivotably couple the mobile device holder to the video game controller, such that the mobile device holder is rotatable between a range of setting angles with respect to the video game controller.

13. The system of claim 12 wherein the video game controller includes a center portion with an opening, the opening configured to receive the mobile device, such that the mobile device holder is rotatable without interference with the center portion.

14. The system of claim 12 wherein the video game controller includes a center portion with a recess, the recess configured to receive the mobile device, such that the mobile device holder is rotatable without interference with the center portion.

15. The system of claim 12 wherein the mobile device holder is rotatable to at least a closed setting, an open setting, and an inclined setting.
